(19) United States
(12) Patent Application Publication
(10) Pub. No.: US 2014/0249701 A1
(43) Pub. Date: Sep. 4, 2014

(54) SYSTEM AND METHOD FOR MANAGING AN INTERVAL BETWEEN AIRCRAFT

(71) Applicant: HONEYWELL INTERNATIONAL INC., Morristown, NJ (US)

(72) Inventors: Emmanuel Latsu-Dake, Shakopee, MN (US); Stephen Whitlow, St. Louis Park, MN (US)

(73) Assignee: HONEYWELL INTERNATIONAL INC., Morristown, NJ (US)

(21) Appl. No.: 13/784,336

(22) Filed: Mar. 4, 2013

(51) Int. Cl. G08G 5/00

(52) U.S. Cl. CPC G08G 5/0021
USPC 701/14

(57) ABSTRACT

A system and method provide situational awareness for a pilot of an ownship in managing the longitudinal interval from an aircraft from which the ownship is following and maintaining the ownship within performance limits by displaying an airspeed bar containing markers representing the ownship minimum and maximum airspeeds, the ownship indicated airspeed, and a commanded interval management airspeed (CIMS) for providing speed situational awareness. A flight management system modifies the CIMS in response to a distance between the aircraft and the ownship. An optional pointer attached to the marker representing the CIMS indicates a trend in the in the CIMS.

### TECHNICAL FIELD

The exemplary embodiments described herein generally relates to longitudinal spacing aircraft in flight and more particularly to managing the interval between aircraft by a pilot.

### BACKGROUND

It is important for pilots to know the position of other aircraft in their airspace that may present a hazard to safe flight. Typical displays that illustrate other aircraft show text to provide important information such as their altitude and speed. This text occupies much of the screen when there are several aircraft being displayed, thereby increasing the chance for pilot confusion. Furthermore, the pilot must interpret the information provided in the text, thereby increasing cognitive workload along with the need to allocate attention to other tasks.

With increased availability of Automated Dependent Surveillance Broadcast (ADS-B) installations, Cockpit Display of Traffic Information (CDTI) displays can show surrounding traffic with increased accuracy and provide improved situation awareness. In the ADSB system, aircraft transponders receive Global Positioning System (GPS) signals and determine the aircraft's precise position, which is combined with other data and broadcast out to other aircraft and air traffic controllers. This display of surrounding traffic increases the pilot's awareness of traffic over and above that provided by Air Traffic Control.

Interval management (IM) is an air traffic management (ATM) procedure to control the interval between air traffic on coincident flight paths. This procedure will help realize the increased throughput expected from Next Generation Air Transportation System (NextGen) by providing precise inter-aircraft spacing relative to another aircraft. Flight Deck Interval Management (FIM) tools are needed to provide guidance to pilots on whether to speed up or slow down to precisely merge their flight paths, and space their aircraft, relative to others.

Some limitations to IM operations relate to the minimum and maximum airspeed that the ownship can be commanded to maintain the specified interval. If the target aircraft slows down there could come a point where the ownship cannot maintain the interval without slowing beyond some safe minimum airspeed. Conversely, if the target aircraft speeds up, there could come a point where the ownship cannot maintain the interval without speeding beyond some safe maximum airspeed. In addition to these boundary speeds, the pilot also needs to monitor other related speeds during IM such as the current indicated airspeed and commanded speed that the pilot has to fly to meet either a required time of arrival (RTA) or a spacing interval behind another aircraft. Operational factors such as winds, turns, descents, and varying aircraft performance characteristics can affect the achieving and/or maintaining of airspeed for the commanded longitudinal spacing interval.

Accordingly, it is desirable to provide a system and method displaying air traffic symbology that a pilot may easily determine whether to vary airspeed within safe limits with respect to another aircraft. Furthermore, other desirable safety features and characteristics of the exemplary embodiments will become apparent from the subsequent detailed description and the appended claims, taken in conjunction with the accompanying drawings and the foregoing technical field and background.

### BRIEF SUMMARY

A system and method are provided for displaying air traffic symbology from which a pilot may easily discern airspeed relationships for interval management.

In an exemplary embodiment, a method of providing commands to a display for assisting a pilot of an ownship in managing the longitudinal interval from an aircraft from which the ownship is following, includes displaying a bar indicating possible airspeeds obtainable by the ownship; displaying a first marker contiguous to a first end of the bar indicating a minimum airspeed obtainable by the ownship; displaying a second marker contiguous to a second end of the bar indicating a maximum airspeed obtainable by the ownship; displaying a third marker on the bar indicating an indicated airspeed of the ownship; displaying a fourth marker on the bar indicating a commanded interval management speed; and modifying the position of the fourth marker in response to the distance between the aircraft and the ownship.

In another exemplary embodiment, a method of assisting a pilot of an ownship in managing the longitudinal interval from an aircraft from which the ownship is following, includes receiving a first location and a first airspeed of the aircraft; determining a second location and a second airspeed of the ownship; calculating a maximum airspeed and a minimum airspeed of the ownship; receiving a commanded airspeed from air traffic control; providing commands to a display for displaying an airspeed bar including a first marker indicating the minimum airspeed, a second marker indicating the maximum airspeed, a third marker indicating the indicated airspeed, and a fourth marker indicating the commanded airspeed; continually determining the distance between the aircraft and the ownship; and adjusting the position of the fourth marker in response to the distance between the aircraft and the ownship.

In yet another exemplary embodiment, a system for assisting a pilot of an ownship in managing the longitudinal interval from an aircraft from which the ownship is following, includes a data link unit configured to receive a commanded interval management airspeed, and both a location and an airspeed of the aircraft; a data source configured to determine a location of the ownship; a sensor configured to determine an indicated airspeed of the ownship; a flight management system configured to determine a minimum airspeed and a maximum airspeed obtainable by the ownship; display a bar indicating an airspeed range; display a first marker contiguous to a first end of the bar indicating the minimum airspeed; display a second marker contiguous to a second end of the bar indicating the maximum airspeed; display a third marker on the bar indicating the indicated airspeed; and display a fourth marker on the bar indicating the commanded interval management airspeed; and modify the commanded interval management airspeed in response to a varying distance between the location of the aircraft and the location of the ownship.

### BRIEF DESCRIPTION OF THE DRAWINGS

The present invention will hereinafter be described in conjunction with the following drawing figures, wherein like numerals denote like elements, and

FIG. 1 is a functional block diagram of a known flight display system;

FIG. 2 is an image in accordance with a first exemplary embodiment that may be rendered on the flight display system of FIG. 1;

FIG. 3 is an image in accordance with a second exemplary embodiment that may be rendered on the flight display system of FIG. 1;

FIG. 4 is an image in accordance with a third exemplary embodiment that may be rendered on the flight display system of FIG. 1;

FIG. 5 is an image in accordance with a fourth exemplary embodiment that may be rendered on the flight display system of FIG. 1;

FIG. 6 is a flow chart of an exemplary method in accordance with the exemplary embodiments; and

FIG. 7 is a flow chart of another exemplary method in accordance with the exemplary embodiments.

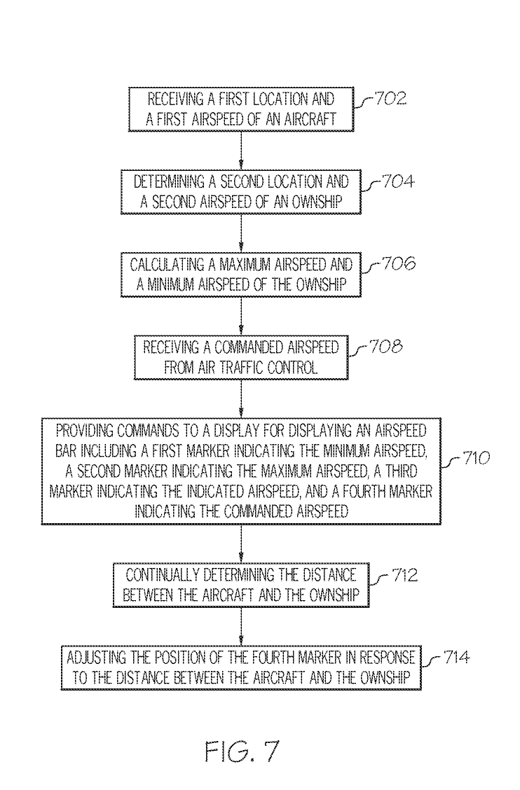

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

While the exemplary embodiments described herein refer to displaying the information on airborne aircraft, the invention may also be applied to other exemplary embodiments such as displays in sea going vessels, and displays used by traffic controllers and unmanned aerial vehicles.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to graphics and image processing, navigation, flight planning, aircraft controls, aircraft data communication systems, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The exemplary embodiments described herein display the minimum and maximum airspeeds, and the indicated airspeed of the ownship, on an airspeed bar for providing speed situational awareness during interval management (IM) to prevent potentially unsafe situations such as stalling or airspeeds beyond the aircrafts performance limits. Displaying these speeds in relation to each other on one integrated display will minimize the potential for confusing the pilot as well as pilot workload during IM. Furthermore, for the entire IM system to function properly it would behoove pilots and air traffic control (ATC) to know if a given aircraft is trending toward being unable to maintain a specified interval. The sooner air traffic control (ATC) acquires this trend knowledge, the more operational flexibility they have in issuing a new IM clearance.

The system calculates the minimum and maximum safe IM speeds using available aircraft state and configuration data, flight parameters such as altitude, current airspeed, as well as other parameters. An integrated display comprising a simple status graphic displayed coincidentally with current commanded IM speed (CIMS) and current indicated airspeed (IAS) provides a graphical representation of where the CIMS is in relation to the calculated minimum and maximum airspeeds. The current CIMS is displayed by a simple marker, for example, a “line” of appropriate width perpendicular to a horizontal bar to indicate relative status at a glance. Additionally, the line could be augmented by an arrow graphic to indicate airspeed data trend over a period of time—giving the pilot additional dynamic data context with a simple graphic.

The integrated display provides the information at a glance to help the pilot easily perceive and understand all the speeds related to IM, their relationship to one another, and to make projections based on the CIMS trend. This assists the pilot to efficiently monitor the status of CIMS and maintain IM operations awareness.

The exemplary embodiments describe an integrated electronic graphical display on an appropriate flight deck display, for example, a multi-function display (MFD), navigation display (ND), primary flight display (PFD), heads up display (HUD, near-to-eye (NTE) display, or an electronic flight bag (EFB) to provide IM speed awareness.

A graphics engine will generate the integrated display using the values of all the information elements of the integrated display. The display elements will be refreshed as their values are updated.

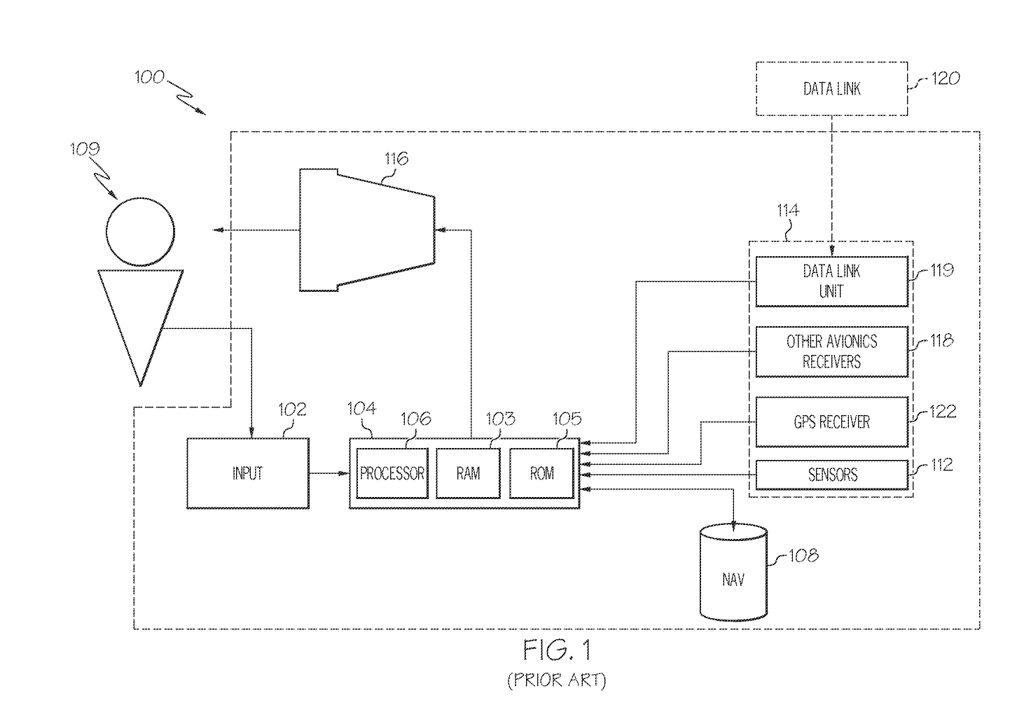

Referring to FIG. 1, an exemplary flight deck display system 100 is depicted and will be described for implementing the present invention. The system 100 includes a user input interface 102, a flight management system (FMS) 104, one or more navigation databases 108, various optional sensors 112 (for the cockpit display version), various external data sources 114, and a display device 116. In some embodiments the user input interface 102 and the display device 116 may be combined in the same device, for example, a touchscreen device. The user interface 102 is in operable communication with the FMS 104 and is configured to receive input from a user 109 (e.g., a pilot) and, in response to the user input, supply command signals to the FMS 104. The user input interface 102 may be any one, or combination, of various known user interface devices including, but not limited to, a cursor control device (not shown), such as a mouse, a trackball, or joystick, and/or a keyboard, one or more buttons, switches, or knobs.

The FMS includes RAM 103, ROM 105, and a processor 106. The processor 106 may be any one of numerous known general-purpose microprocessors or an application specific processor that operates in response to program instructions. In the depicted embodiment, the FMS 104 includes on-board RAM (random access memory) 103, and on-board ROM (read only memory) 105. The program instructions that control the processor 106 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 106 may be implemented using various other circuits, not just a programmable processor. For example, digital logic circuits and analog signal processing circuits could also be used.

No matter how the FMS 104 is specifically implemented, it is in operable communication with the navigation databases 108, and the display device 116, and is coupled to receive various types of aircraft state data from the various sensors 112, and various other environment related data from the external data sources 114. The FMS 104 is configured, in response to the inertial data and the avionics-related data, to selectively retrieve navigation data from one or more of the navigation databases 108, and to supply appropriate display commands to the display device 116. The display device 116, in response to the display commands from, for example, a touch screen, keypad, cursor control, line select, concentric knobs, voice control, and data link message, selectively renders various types of textual, graphic, and/or iconic information. The preferred manner in which the textual, graphic, and/or iconic information are rendered by the display device 116 will be described in more detail further below. Before doing so, however, a brief description of the databases 108, the sensors 112, and the external data sources 114, at least in the depicted embodiment, will be provided.

The navigation databases 108 include various types of navigation-related data. These navigation-related data include various flight plan related data such as, for example, waypoints, distances between waypoints, headings between waypoints, data related to different airports, navigational aids, obstructions, special use airspace, political boundaries, communication frequencies, and aircraft approach information. It will be appreciated that, although the navigation databases 108 are, for clarity and convenience, shown as being stored separate from the FMS 104, all or portions of either or both of these databases 108 could be loaded into the RAM 103, or integrally formed as part of the FMS 104, and/or RAM 103, and/or ROM 105. The navigation databases 108 could also be part of a device or system that is physically separate from the system 100.

The sensors 112 may be implemented using various types of sensors, systems, and or subsystems, now known or developed in the future, for supplying various types of aircraft state data. The state data may also vary, but preferably include data representative of the geographic position of the aircraft and also other data such as, for example, aircraft speed, heading, altitude, rate of climb/descent, and attitude.

The number and type of external data sources 114 (or subsystems) may also vary, but typically include for example, a GPS receiver 122, other avionics receivers 118, and a data link unit 119. The other avionics receivers would include, for example, a terrain avoidance and warning system (TAWS), a traffic and collision avoidance system (TCAS), a runway awareness and advisory system (RAAS), a flight director, and a navigation computer.

ADS-B relies on two avionics components—a high-integrity GPS navigation source and a data link (ADS-B unit). The GPS receiver 122 is a multi-channel receiver, with each channel tuned to receive one or more of the GPS broadcast signals transmitted by the constellation of GPS satellites (not illustrated) orbiting the earth. Each GPS satellite encircles the earth two times each day, and the orbits are arranged so that at least four satellites are always within line of sight from almost anywhere on the earth. The GPS receiver 122, upon receipt of the GPS broadcast signals from at least three, and preferably four, or more of the GPS satellites, determines the distance between the GPS receiver 122 and the GPS satellites and the position of the GPS satellites. Based on these determinations, the GPS receiver 122, using a technique known as trilateration, determines, for example, aircraft position, groundspeed, and ground track angle. These data may be supplied to the FMS 104, which may determine aircraft glide slope deviation therefrom. Preferably, however, the GPS receiver 122 is configured to determine, and supply data representative of, aircraft glide slope deviation to the FMS 104.

The display device 116, as noted above, in response to display commands supplied from the FMS 104, selectively renders various textual, graphic, and/or iconic information, and thereby supply visual feedback to the user 109. It will be appreciated that the display device 116 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 116 may additionally be implemented as a panel mounted display, a HUD (head-up display) projection, a near-to-eye display, or any one of numerous known technologies. It is additionally noted that the display device 116 may be configured as any one of numerous types of aircraft flight deck displays. For example, it may be configured as a multi-function display, a horizontal situation indicator, or a vertical situation indicator, just to name a few. In the depicted embodiment, however, the display device 116 is configured as a primary flight display (PFD).

In operation, the display device 116 is also configured to process the current flight status data for the host aircraft. In this regard, the sources of flight status data generate, measure, and/or provide different types of data related to the operational status of the host aircraft, the environment in which the host aircraft is operating, flight parameters, and the like. In practice, the sources of flight status data may be realized using line replaceable units (LRUs), transducers, accelerometers, instruments, sensors, and other well known devices. The data provided by the sources of flight status data may include, without limitation: airspeed data; groundspeed data; altitude data; rate of climb/descent data, attitude data, including pitch data and roll data; yaw data; geographic position data, such as GPS data; time/date information; heading information; weather information; flight path data; track data; radar altitude data; geometric altitude data; wind speed data; wind direction data; etc. The display device 116 is suitably designed to process data obtained from the sources of flight status data in the manner described in more detail herein. In particular, the display device 116 can use the flight status data of the host aircraft when rendering the IM display.

In an exemplary embodiment, the data link unit 119 is suitably configured to support data communication between the host aircraft and one or more remote systems (data link 120). More specifically, the data link unit 119 is used to receive current flight status data of other aircraft that are near the host aircraft. In particular embodiments, the data link unit 119 is implemented as an aircraft-to-aircraft data communication module that receives flight status data from an aircraft other than the host aircraft. For example, the data link unit 119 may be configured for compatibility with Automatic Dependent Surveillance-Broadcast (ADS-B) technology, with Traffic and Collision Avoidance System (TCAS) technology, and/or with similar technologies. Examples of the data received include, for example, weather information, traffic information (including locations and airspeeds), route changes, and specifically clearances and alerts (including NOTAMS) describing, for example, hazardous situations.

The data link unit 119 also enables the host aircraft to communicate with Air Traffic Control (ATC). In this regard, the data link unit 119 may be used to provide ATC data to the host aircraft and/or to send information from the host aircraft to ATC, preferably in compliance with known standards and specifications.

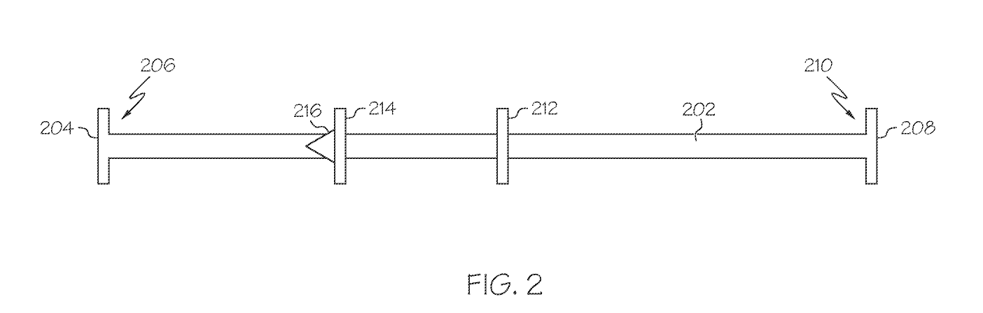

Referring to FIG. 2, a first exemplary embodiment of the display includes a horizontal bar, or line, 202 having a marker 204 on a first end 206 and another marker 208 on a second end 210. The horizontal bar 202 represents the safe airspeeds in which the own ship is capable of flying based on IM commands issued by ATC. The marker 204 represents the minimum airspeed in which the own ship may safely fly, and the marker 208 represents the maximum airspeed the own ship is capable of flying based on IM commands. The minimum and maximum airspeeds are calculated by the processor 104 based on flight parameters determined by the sensors 112 and FMS 104, for example, own ship type, configuration, altitude, airspeed, and weight. The marker 212 denotes the indicated airspeed as determined by the sensors 112, and, optionally, the marker 214 denotes the CIMS as directed by ATC, subsequently modified by the FMS 104, or manually modified on the mode control panel (MCP). A pointer 216 associated with the marker 214 indicates a trend in movement of the speed up or down in magnitude.

In operation, a CIMS is received from ATC for following a specified aircraft. The maximum and minimum airspeeds, as well as the location and airspeed of the ownship, are determined by the FMS 104. The location and airspeed of the aircraft to be followed are received, preferably directly from the aircraft, but optionally, for example, from ATC. The FMS 104 provides display commands to the display 116 for displaying the bar 202, markers 204, 206 for the minimum and maximum airspeeds for the ownship, the marker 212 for the indicated airspeed of the ownship, and the marker 214 for the CIMS. The FMS 104 continually updates the locations and airspeeds of the ownship and aircraft to be followed, and as the interval, or spacing, between the ownship and aircraft varies, modifies the CIMS and moves the marker 214 appropriately along the bar 202 to maintain the proper spacing between the ownship and the aircraft.

The optional pointer 216 is displayed when the FMS 104 determines a trend in movement of the marker 214 for an increasing or decreasing along the bar 202. As displayed, the pointer 216 is indicating a decreasing trend towards the minimum airspeed marker 206.

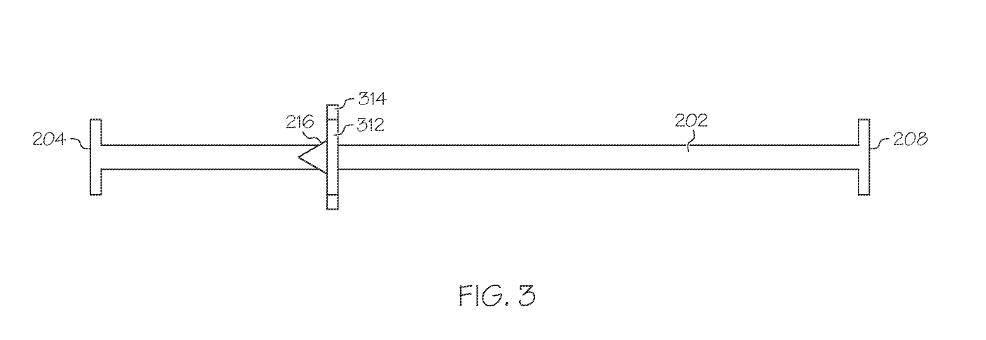

FIG. 3 is a second exemplary embodiment wherein the CIMS and the indicated speed are the same. The CIMS marker 314 extends beyond (is larger in size) and is positioned behind (as viewed) the indicated airspeed marker 312, thereby allowing the pilot to see both markers 312, 314. Alternatively, the indicated airspeed marker 312 could extend beyond and be positioned behind the commanded interval management speed marker 314 (not shown).

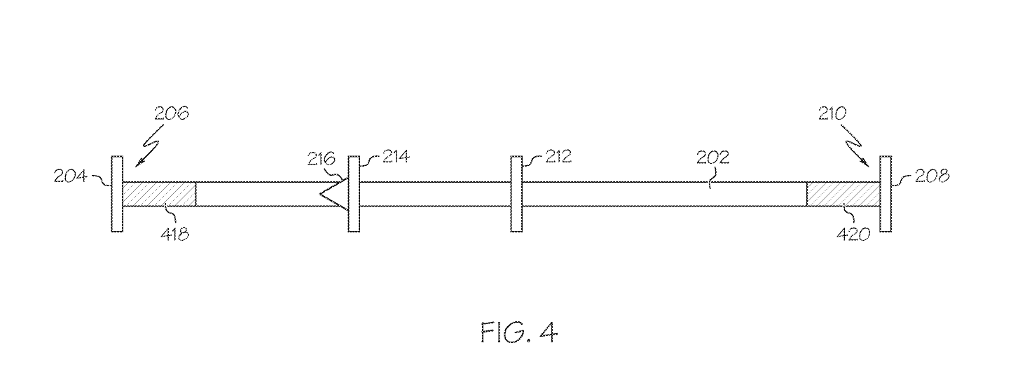

Referring to FIG. 4, a third exemplary embodiment of the bar 202 includes alert ranges 418 and 420. Alert range 418 is a portion of the bar 202 adjacent the minimum airspeed marker 204 and is formatted differently from the bar 202 for alerting the pilot that the indicated airspeed or the CIMS airspeed is close to or approaching the minimum airspeed. Likewise, the alert range 420 is a portion of the bar 202 adjacent the maximum airspeed marker 206 and is formatted differently from the bar 202 for alerting the pilot that the indicated airspeed or the CIMS airspeed is close to or approaching the maximum airspeed.

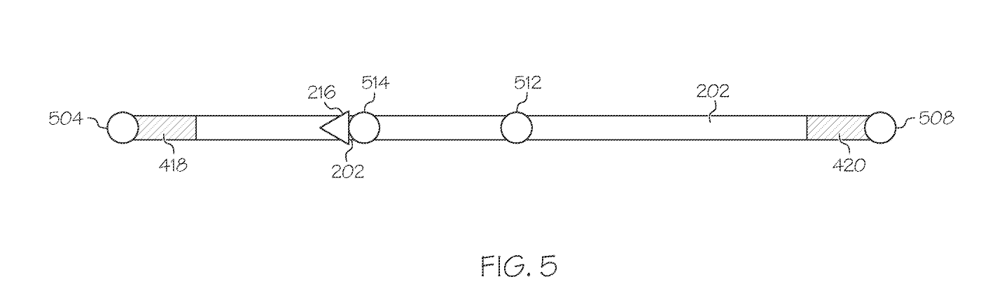

Different format as used herein means of a different appearance, for example, a different shape, color, shade, or fill. FIG. 5 illustrates where the marker 504 (minimum airspeed), 508 (maximum airspeed), 512 (indicated airspeed), and 514 (CIMS airspeed) are of a different format than in the previously described embodiments.

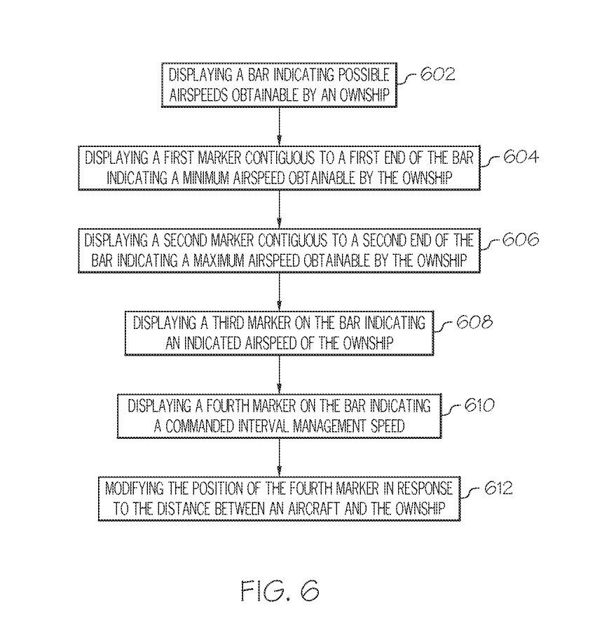

FIG. 6 is a flow chart that illustrates an exemplary embodiment of a process 600 suitable for use with a flight deck display system. The various tasks performed in connection with process 600 may be performed by software, hardware, firmware, or any combination thereof For illustrative purposes, the following description of process 600 may refer to elements mentioned above in connection with FIGS. 2-5. In practice, portions of process 600 may be performed by different elements of the described system, e.g., a processor, a display element, or a data communication component. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. Moreover, one or more of the tasks shown in FIG. 6 could be omitted from an embodiment of the process 600 as long as the intended overall functionality remains intact.

A first exemplary method embodiment describes providing commands to a display for assisting a pilot of an ownship in managing the interval from an aircraft from which the ownship is following, including displaying 602 a bar indicating possible airspeeds obtainable by the ownship; displaying 604 a first marker contiguous to a first end of the bar indicating a minimum airspeed obtainable by the ownship; displaying 606 a second marker contiguous to a second end of the bar indicating a maximum airspeed obtainable by the ownship; displaying 608 a third marker on the bar indicating an indicated airspeed of the ownship; displaying 610 a fourth marker on the bar indicating a commanded interval management speed; and modifying 612 the position of the fourth marker in response to the distance between the aircraft and the ownship.

A second exemplary method embodiment describes assisting a pilot of an ownship in managing the interval from an aircraft from which the ownship is following, including receiving 702 a first location and a first airspeed of the aircraft; determining 704 a second location and a second airspeed of the ownship; calculating 706 a maximum airspeed and a minimum airspeed of the ownship; receiving 708 a commanded airspeed from air traffic control; providing 710 commands to a display for displaying an airspeed bar including a first marker indicating the minimum airspeed, a second marker indicating the maximum airspeed, a third marker indicating the indicated airspeed, and a fourth marker indicating the commanded airspeed; continually determining 712 the distance between the aircraft and the ownship; and adjusting 714 the position of the fourth marker in response to the distance between the aircraft and the ownship.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method of providing commands to a display for assisting a pilot of an ownship in managing the longitudinal interval from an aircraft from which the ownship is following, comprising:
displaying a bar indicating possible airspeeds obtainable by the ownship;
displaying a first marker contiguous to a first end of the bar indicating a minimum airspeed obtainable by the ownship;
displaying a second marker contiguous to a second end of the bar indicating a maximum airspeed obtainable by the ownship;
displaying a third marker on the bar indicating an indicated airspeed of the ownship;
displaying a fourth marker on the bar indicating a commanded interval management speed; and
modifying the position of the fourth marker in response to the distance between the aircraft and the ownship.

2. The method of claim 1 further comprising:
calculating the minimum airspeed and maximum airspeed by considering at least one of the ownship flight parameters selected from the group consisting of ownship configuration, type, altitude, and weight.

3. The method of claim 1 further comprising:
calculating the minimum airspeed and maximum airspeed by considering at least one of the factors selected from the group consisting of winds and flight procedures including turns, climbs, and descents.

4. The method of claim 1 further comprising:
receiving the commanded interval management speed as data from air traffic control.

5. The method of claim 1 further comprising:
determining if a change in distance between the ownship and the aircraft has occurred;
modifying the commanded interval management speed in response to the change in distance; and
displaying a pointer adjacent to the fourth marker indicating a trend of the modified commanded interval management speed.

6. The method of claim 4 further comprising:
receiving the location and airspeed of the aircraft as data from the aircraft;
determining the location and airspeed of the ownship; and
calculating the distance between the aircraft and the ownship.

7. The method of claim 4 further comprising:
transmitting the trend to air traffic control.

8. A method of assisting a pilot of an ownship in managing the longitudinal interval from an aircraft from which the ownship is following, comprising:
receiving a first location and a first airspeed of the aircraft;
determining a second location and a second airspeed of the ownship;
calculating a maximum airspeed and a minimum airspeed of the ownship;
receiving a commanded airspeed from air traffic control;
providing commands to a display for displaying an airspeed bar including a first marker indicating the minimum airspeed, a second marker indicating the maximum airspeed, a third marker indicating the indicated airspeed, and a fourth marker indicating the commanded airspeed;
continually determining the distance between the aircraft and the ownship; and
adjusting the position of the fourth marker in response to the distance between the aircraft and the ownship.

9. The method of claim 8 further comprising:
calculating the minimum airspeed and maximum airspeeds by considering at least one of the ownship flight parameters selected from the group consisting of ownship configuration, type, altitude, and weight.

10. The method of claim 8 further comprising:
receiving the commanded interval management speed as data from air traffic control.

11. The method of claim 8 further comprising:
determining if a change in distance between the ownship and the aircraft has occurred;
modifying the commanded interval management speed in response to the change in distance; and
displaying a pointer adjacent to the fourth marker indicating a trend of the modified commanded interval management speed.

12. The method of claim 11 further comprising:
receiving the location and airspeed of the aircraft as data from the aircraft;
determining the location and airspeed of the ownship; and
calculating the distance between the aircraft and the ownship.

13. The method of claim 11 further comprising:
transmitting the trend to air traffic control.

14. A system for assisting a pilot of an ownship in managing the longitudinal interval from an aircraft from which the ownship is following, the system comprising:
a data link unit configured to receive a commanded interval management airspeed, and both a location and an airspeed of the aircraft;
a data source configured to determine a location of the ownship;
a sensor configured to determine an indicated airspeed of the ownship;
a flight management system configured to:
determine a minimum airspeed and a maximum airspeed obtainable by the ownship;
display a bar indicating an airspeed range;
display a first marker contiguous to a first end of the bar indicating the minimum airspeed;
display a second marker contiguous to a second end of the bar indicating the maximum airspeed;
display a third marker on the bar indicating the indicated airspeed; and
display a fourth marker on the bar indicating the commanded interval management airspeed; and
modify the commanded interval management airspeed in response to a varying distance between the location of the aircraft and the location of the ownship.

15. The system of claim 14 wherein the data link unit is further configured to:
receive the location and airspeed of the aircraft as data from the aircraft.

16. The system of claim 14 wherein the flight management system is further configured to:
calculate the minimum airspeed and maximum airspeed by considering at least one of the ownship flight parameters selected from the group consisting of ownship configuration, type, altitude, and weight.

17. The system of claim 14 wherein the flight management system is further configured to:
calculate the minimum airspeed and maximum airspeed by considering at least one of the ownship flight parameters selected from the group consisting of winds and flight procedures including turns, climbs, and descents.

18. The system of claim 14 wherein the flight management system is further configured to:
determine if a change in distance between the ownship and the aircraft has occurred;
modify the commanded interval management speed in response to the change in distance; and
display a pointer adjacent to the fourth marker indicating a trend of the modified commanded interval management speed.

19. The system of claim 18 wherein the flight management system is further configured to:
receive the location and airspeed of the aircraft as data from the aircraft;
determine the location and airspeed of the ownship; and
calculate the distance between the aircraft and the ownship;

20. The method of claim 18 further comprising:
transmitting the trend to air traffic control.
